(19) United States
(12) Patent Application Publication
(10) Pub. No.: US 2012/0159536 A1
(43) Pub. Date: Jun. 21, 2012

(54) INFORMAL CONTENT SCHEDULING SYSTEM AND METHOD

(76) Inventors: Paul Treacy, Belmont (NZ); Steve Castellotti, Media, PA (US)

(21) Appl. No.: 13/392,821

(22) PCT Filed: Aug. 23, 2010
(86) PCT No.: PCT/NZ2010/000163

§ 371 Date: Feb. 27, 2012

Related U.S. Application Data
(60) Provisional application No. 61/237,594, filed on Aug. 27, 2009.

(51) Int. Cl. H04N 21/458

(52) U.S. Cl. 725/32

(57) ABSTRACT

A system for scheduling the output of informational content received from an informational content source with media content, the system including an informational content scheduling module arranged to: monitor media content as it is received from a media content source, analyze the media content to capture media content context data that identifies the context of the media content, retrieve location information based on the location of an informational content output device arranged to output informational content, correlate the media content context data with informational content context data, wherein the informational content context data identifies the context of informational content, and utilize a set of pre-stored rules, determining the scheduling of the informational content based on the correlation of the media content context data and informational content context data, and the location information.

### FIELD OF THE INVENTION

The present invention relates to an informational content scheduling system and method. In particular, the present invention relates to an informational content scheduling system and method wherein media content is analysed to identify and schedule informational content that correlates with the media content.

### BACKGROUND

Various systems are known to be able to display informational content (such as advertisements etc) alongside media content (such as broadcast television etc). These systems generally stop the display of the media content and insert the informational content for display within a temporal slot.

Further, systems have been developed that enable informational content to be displayed on the same screen as the media content is being displayed.

For example, U.S. Pat. No. 7,509,267 and US patent application US 2001/0043285 describe systems that combine commercial content signals with video signals to enable them to be displayed together. However, this system may not be compatible in areas where the adaptation of broadcast signals is not legally permitted. Further, the commercial content displayed with the video signals is unrelated to the video signals being displayed.

Digital signage systems enable the display of content to consumers in various public spaces. The signage systems may be incorporated in areas where media content in a different form is also being provided to a consumer, such as in a sports bar where sporting programs are displayed alongside digital signage systems that are advertising beverages. However, the content displayed on the digital signage system is generally in the form of fixed adverts and messages directed towards the consumer for a specific set purpose unrelated to the media content currently being displayed.

Digital out of home (DOOH) systems may enable a user to modify the digital output displayed on such systems according to a desired profile. However, these known systems do not provide dynamic adaptation of the informational content that is displayed based on media content being output on separate devices. Further, these systems do not take into account the context of media content and the location where the media content is being output to determine the informational content being displayed.

An object of the present invention is to provide a system or method that improves the correlation between informational content and media content being output on various output devices.

A further object of the present invention is to provide a system or method that dynamically outputs informational content based on monitored media content.

A further object of the present invention is to provide a system or method that provides contextually relevant informational content for display simultaneously with media content.

A further object of the present invention is to provide a system or method that utilizes contextual data associated with informational content and media content, along with location data to determine the output of informational content.

Each object is to be read disjunctively with the object of at least providing the public with a useful choice.

The present invention aims to overcome, or at least alleviate, some or all of the afore-mentioned problems.

### SUMMARY OF THE INVENTION

The present invention provides a system and method that analyses media content to identify and schedule informational content that correlates with the media content.

According to one aspect, the present invention provides, in an informational content scheduling system, a computer implemented method for scheduling the output of informational content received from an informational content source with media content, the method including the steps of an informational content scheduling module: monitoring media content output from an independent media content source, analysing the received media content, wherein the analysis captures media content context data that identifies the context of the media content, identifying informational content to be scheduled by correlating the media content context data with informational content context data, wherein the informational content context data identifies the context of the informational content, scheduling the informational content based on the correlating step, detecting whether the informational content is scheduled, and upon a positive determination, modifying the format of the media content to enable the informational content and media content to be displayed simultaneously, wherein the format of the media content is modified by adjusting the size of an image of the media content.

According to a further aspect, the present invention provides, an informational content scheduling system for scheduling the output of informational content received from an informational content source with media content, the system including an informational content scheduling module arranged to: monitor media content output from an independent media content source, analyze the received media content, wherein the analysis captures media content context data that identifies the context of the media content, identify informational content to be scheduled by correlating the media content context data with informational content context data, wherein the informational content context data identifies the context of the informational content, schedule the informational content based on the correlation of the media content with the information content, detect whether the informational content is scheduled, and upon a positive determination, modify the format of the media content to enable the informational content and media content to be displayed simultaneously, wherein the format of the media content is modified by adjusting the size of an image of the media content.

One advantage provided by specific embodiments of the present invention is that of being able to dynamically analyze media content as it is received and output on a media content output device, and contextually match informational content with the media content.

One of the challenges of displaying informational content is to try and ensure the informational content best matches the environment in which it is displayed. Various embodiments of the present invention enable contextually relevant informational content to be output with media content in the same environment.

Further, the use of forceful advertising enables informational content providers to increase the chances of their message being conveyed to individuals without the individual ignoring the informational content. Forceful advertising is intended to mean the user may view the informational content and has no control over it. For example, the user is not able to avoid the advertising by changing channels.

Various embodiments of the present invention enable contextually relevant informational content to be output simultaneously with the media content on the same screen without the need to disrupt the reception of the media content.

### BRIEF DESCRIPTION OF THE DRAWINGS

Embodiments of the present invention will now be described, by way of example only, with reference to the accompanying drawings, in which:

FIG. 1 shows a system block diagram according to an embodiment of the present invention;

FIG. 2 shows a further system block diagram according to an embodiment of the present invention;

FIG. 3 shows a further system block diagram according to an embodiment of the present invention;

FIG. 4 shows a further system block diagram according to an embodiment of the present invention;

FIG. 5 shows a further system block diagram according to an embodiment of the present invention;

FIG. 6 shows a further system block diagram according to an embodiment of the present invention;

FIG. 7 shows a further system block diagram according to an embodiment of the present invention;

FIG. 8 shows a system block diagram of an analysis module used to process closed caption signals according to an embodiment of the present invention;

FIG. 9 shows a system block diagram of an analysis module used to process audio signals according to an embodiment of the present invention;

FIG. 10 shows a system block diagram of an analysis module used to process video signals according to an embodiment of the present invention;

FIG. 11 shows a conceptual block diagram of an informational content scheduling system according to an embodiment of the present invention;

FIG. 12 shows a conceptual flow diagram of data according to an embodiment of the present invention;

FIG. 13 shows a further conceptual system diagram according to an embodiment of the present invention;

FIG. 14 shows a flow diagram of channel detection according to an embodiment of the present invention;

FIG. 15 shows a conceptual view of how media content may be adapted to enable informational content to be simultaneously displayed;

### DETAILED DESCRIPTION OF THE INVENTION

The present invention may be applied in various different technical fields and is not limited only to those specific examples discussed in detail. One particular relevant technical field is that of multimedia technologies, and more specifically the technical field of video and audio messaging systems.

Although the following embodiments are described with reference to digital out of home (DOOH) systems, it will be understood that the scheduling system described may be implemented using other suitable systems that output media content.

It will be understood that the system herein described includes one or more elements that are arranged to perform the various functions and methods as described herein. The description is aimed at providing the reader with an example of a conceptual view of how various modules and/or engines that make up the elements of the system may be interconnected to enable the functions to be implemented. Further, the description explains in system related detail how the steps of the herein described method may be performed. The conceptual diagrams are provided to indicate to the reader how the various data elements are processed at different stages by the various different modules and/or engines.

It will be understood that the arrangement and construction of the modules or engines may be adapted accordingly depending on system and user requirements so that various functions may be performed by different modules or engines to those described herein.

It will be understood that the modules and/or engines described may be implemented and provided with instructions using any suitable form of technology. For example, the modules or engines may be implemented or created using any suitable software code written in any suitable language, where the code is then compiled to produce an executable program that may be run on any suitable computing system. Various components of the software code may be made available for implementation on any suitable system by being provided on or over any suitable medium. For example, the software may be downloaded over the Internet, or made available on a hard disk drive, memory device, flash drive, data store, CD ROM, DVD etc.

Alternatively, or in conjunction with the executable program, the modules or engines may be implemented using any suitable mixture of hardware, firmware and software. For example, portions of the modules may be implemented using an application specific integrated circuit (ASIC), a system-on-a-chip (SoC), field programmable gate arrays (FPGA) or any other suitable adaptable or programmable processing device.

In summary, the system herein described includes at least a processor, one or more memory devices or an interface for connection to one or more memory devices, input and output interfaces for connection to external devices in order to enable the system to receive and operate upon instructions from one or more users or external systems, a data bus for internal and external communications between the various components, and a suitable power supply. Further, the system may include one or more communication devices (wired or wireless) for communicating with external and internal devices, and one or more input/output devices, such as a display, pointing device, keyboard or printing device.

The processor is arranged to perform the steps of a program stored as program instructions within the memory device. The program instructions enable the various methods of performing the invention as described herein to be performed. The program instructions may be developed or implemented using any suitable software programming language and toolkit, such as, for example, a C-based language. Further, the program instructions may be stored in any suitable manner such that they can be transferred to the memory device or read by the processor, such as, for example, being stored on a computer readable medium. The computer readable medium may be any suitable medium, such as, for example, solid state memory, magnetic tape, a compact disc (CD-ROM or CD-R/W), memory card, flash memory, optical disc, magnetic disc or any other suitable computer readable medium.

The system may be arranged to be in communication with external data storage systems or devices in order to retrieve the relevant data.

### First Embodiment

DOOH systems generally use digital signage systems to display media content in public areas. Digital signage systems and devices have the ability to schedule and play digital content on liquid crystal displays, projections or on embedded screens such as automated teller machines, airplane chair backs or kiosks. Many of these systems incorporate audio and video feeds that are played through the viewer and audio system. Various embodiments of the present invention are described that enable unique ways to schedule and play content on digital screens such as those used in DOOH systems.

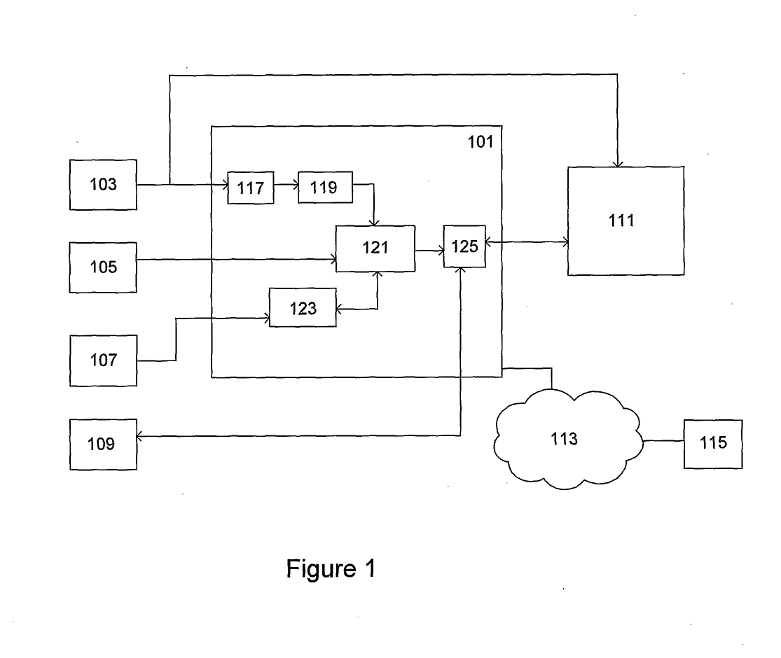

Referring to FIG. 1, a system block diagram is shown identifying various system components that may be used in an informational content scheduling system.

The term scheduling includes determining when and where informational content is played, as well as whether it is played or not. I.e. scheduling determines not only the timing and locality for displaying informational content, but also which informational content is to be played.

The system includes a scheduling module 101 for scheduling informational content. The informational content scheduling module may be a stand alone device or may be incorporated within or form at least part of a DOOH device arranged to receive or output audio signals, video signals or a combination thereof.

Informational content may include advertisements, alert messages, advisory messages etc. Informational content is distinct from media content.

Informational content may be scheduled based on a number of criteria defined in a set of pre-stored rules and based on the value of identified key elements such as key words, key phrase or key images with which they are associated. The rules may be directed towards advert on advert avoidance, advert on specific channel avoidance or keeping adverts from being shown during a specific program. The rules and scheduling are tied to key elements. The rules identify the parameters for when informational content can or should be played or when it shouldn't, but the actual scheduling is determined by the key elements. The key elements can be assigned values in a database which gives the marketer the ability to assign values to key elements that are more attractive to potential advertisers.

Alternatively, the informational content scheduling module may form part of a television device, a mobile television device, a multimedia playing device, a home computing device, a portable computing device, a portable communication device, a satellite signal receiving device, a terrestrial broadcast signal receiving device, a digital data receiving device, a cable signal receiving device, a multi entertainment device, a photograph display device, a presentation device, or any other suitable device that is capable of outputting media content.

As shown in FIG. 1, the informational content scheduling module monitors media content as it is received from a media content source 103. The media content source may be an independent source such that the informational content scheduling module has no control over the media content that is output from the source.

The media content source may be arranged to transmit, broadcast, multicast, uni-cast, data stream or otherwise transfer media content from the media content source to a media content output device. For example, the media content may be broadcast from a television studio transmission site, transmitted via a satellite, output form a web server as a data stream formed from IP packets, etc. The media content may be formed from audio content, video content or a combination thereof. It may therefore be transmitted using any suitable audio transmission system, visual transmission system or a combination thereof. For example, the media content may consist of terrestrial television data, mobile television data or web television data.

One or more content-based sources 105 are also in communication with the informational content scheduling module. A content-based source may include for example one or more weather content sources, news content sources, financial content sources, entertainment content sources and sports content sources. These sources effectively provide the informational content scheduling module with further ancillary information associated with various topics that may be of interest or relevance to a consumer, and which may help provide more relevant informational content or help determine the context of the media content more accurately.

The informational content scheduling module is also in communication with an informational content context data database 107. The informational content context data database stores informational content context data associated with various pieces of informational content. The informational content context data is used to identify relevant informational content using various techniques as will be described in more detail below.

An informational content source 109 is also in communication with the informational content scheduling module. Informational content is made available from the informational content source. The informational content may include advertisements, alert messages or advisory messages. That is, the informational content is content that is additional to the media content.

An output device 111 receives an output from the informational content scheduling module 101. The output device in this embodiment is a combination of a media content output device and informational content output device. That is, both the media content and informational content are output from one and the same device. For example, the output device may be an LCD screen, plasma screen, television set, video output device, audio output device, multimedia player or any suitable output device that is able to play media content.

The informational content scheduling module is also in communication with the Internet 113, and a web interface 115 is provided to enable an administrator to monitor and modify how the informational content scheduling module operates. By retrieving usage data from the informational content scheduling module, the web interface may be used to provide detailed reports on the informational content and media content that has been output, for example. The web interface may be displayed using any suitable known computing device using standard known techniques.

The informational content scheduling module 101 will now be described in more detail. A receiving module 117 is arranged to receive the media content from the media content source 103. According to this embodiment, the media content is received as a continuous data stream as it is output from the media content source. That is, the media content is received by the informational content scheduling module in real time and is not pre-stored prior to receiving the media content, or stored after reception and prior to analysis.

After the receiving module 117 has received the media content, it forwards the media content to an analysis module 119. The analysis module dynamically analyses the media content to determine its context. That is, the analysis module analyses the incoming stream of media content to determine, or capture, media content context data from the stream, as will be described in more detail below.

Optionally, the system may include third-party databases (for example forming part of the content based source module 105) that are arranged to store further pre-stored media content context data. This context data may be retrieved by the informational content scheduling module after an initial analysis stage to help with determining the true context of the media content. That is, by using the analyzed data to produce an initial set of media content context data and then cross analyzing those results with further media content context data, a more accurate picture of the media content context may be achieved.

The media content context data is received by a correlation module 121 which has incorporated therein a rules engine. The rules engine utilizes a set of pre-stored rules that use the media content context data, informational content context data and optionally other data inputs (such as location data, ambient data, content based data etc) to determine how and when informational content is to be scheduled.

The correlation module may match or correlate the media content context data with informational content context data in order to identify relevant or matched informational content. That is, the informational content context data identifies the context of the informational content, and so the context of the media content and informational content can be matched.

The correlation module 121 communicates with an informational content context data storage module 123, which stores informational content context data that has previously been determined and stored. In this embodiment, the informational content context data storage module 123 is integral to the informational content scheduling module, but it will be understood that the informational content context data storage module may, as an alternative, be external to the system and may be arranged to communicate with the informational content scheduling module using any suitable form of communication protocols.

The correlation module correlates the media content context data and informational content context data to identify associated informational content for scheduling. That is, the correlation module determines from the media content context data, informational content context data and an optional set of pre-stored rules whether there is any informational content that matches the incoming media content. If there is determined to be a match, the correlation module 121 communicates with a scheduler 125 to provide it with identification data that identifies the relevant informational content. As an alternative, the identification data may include the informational content itself.

The scheduler 125 retrieves the corresponding informational content from the informational content source 109 and forwards the informational content to the output device.

It will be understood that, as an alternative, the scheduler 125 may forward the informational content identification data to the output device, which in turn retrieves the informational content from any suitable source.

The output device 111 also receives the media content from the media content store at the same time as it is received by the informational content scheduling module. Therefore, the output device may continuously, without interruptions, output the media content regardless of the operations of the informational content scheduling module.

According to this embodiment, the informational content is transmitted, transferred, forwarded or otherwise communicated to the output device 111 by the scheduler 125 of the informational content scheduling module 101 in a form that enables the media content and the informational content to be output on the output device 111 contemporaneously, and optionally simultaneously. That is, the media content and informational content are output at substantially the same time, successively or within a short period of time.

As will be explained in more detail below, the informational content scheduling module may also receive location information that conveys the location of the informational content output device. For example, this location information may be received directly from the informational content output device by the scheduler 125. The location information may then be used in conjunction with the media content contextual data to determine the informational content schedule.

In the situation where the media content is combined video and audio content (such as forming part of a TV signal for example) and the informational content is also combined video and audio content (such as forming part of an advertisement for example), the informational content video signal may be placed over the top of the media content video signal to enable the informational content to be viewed at the same time as the media content. For example, the informational content video may be made transparent in comparison to the media content video in order to enable both video images to be viewed simultaneously.

By enabling the media content and informational content to be displayed simultaneously, a form of forceful advertising takes place that does not interrupt the output of media content.

The relative volumes of the audio signals of the media content and informational content may be automatically adjusted to enable the informational content audio to be heard over the top of the media content audio. For example, the volume of the informational content audio may be made louder than that of the media content audio. As an alternative, the signal transmitted by the scheduler 125 may incorporate an audio control signal that causes the output device to mute, or at least reduce, the volume of the media content audio.

According to this embodiment, the scheduled informational content and media content are output at substantially the same time, or at least contemporaneously such that, when the system is in use, when an individual receives the media content they are also in a position to receive the informational content in whichever form the media content and informational content are being output. Therefore, the system provides a mechanism for producing contextually relevant informational content that is relevant to the current media content being output.

Prior to describing more details of how various components of the system operate, various alternative arrangements are now discussed.

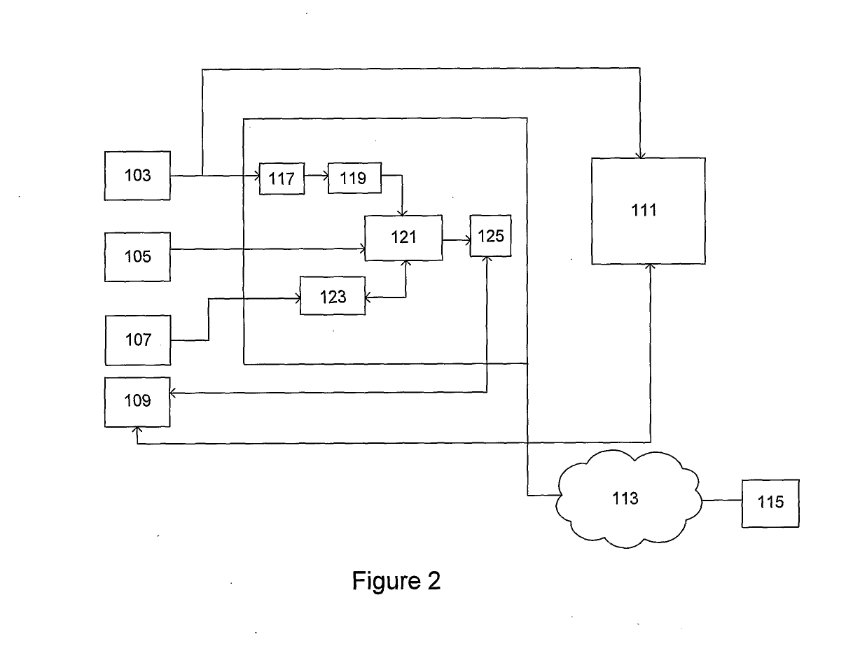

In an alternative embodiment as shown in FIG. 2, the system is similar as described above with reference to FIG. 1 including any alternatives described. However, in this embodiment, scheduler 125 does not directly communicate the informational content to the output device but communicates scheduling instructions directly to the informational content source 109, which effectively acts as an informational content server. The informational content source 109 transfers the informational content to the output device 111 according to the schedule sent by the informational content scheduler 125 so that the informational content may be displayed on the output device with the media content in a similar manner as described in the first embodiment.

In this embodiment, the scheduling instructions include a list of the informational content that is to be displayed on the output device based on the contextual analysis of the media content. For example, the list may identify one or more advertisements stored at the source 109 for simultaneous output with the media content based on the contextual match. The list may include identification data that instructs the informational content source which informational content it should forward to the output device, and at what time. Further, the list may identify the timing or order in which the informational content is to be played. For example, more than one piece of informational content may be placed in the schedule to enable a series of informational content pieces to be output in sequence. That is, the identification data enables the informational content source to identify the relevant informational content from the identification data. For example, the identification data may merely be a reference to a specific advertisement, a reference to specific advertisers or a reference to specific products that are to be played on the output device.

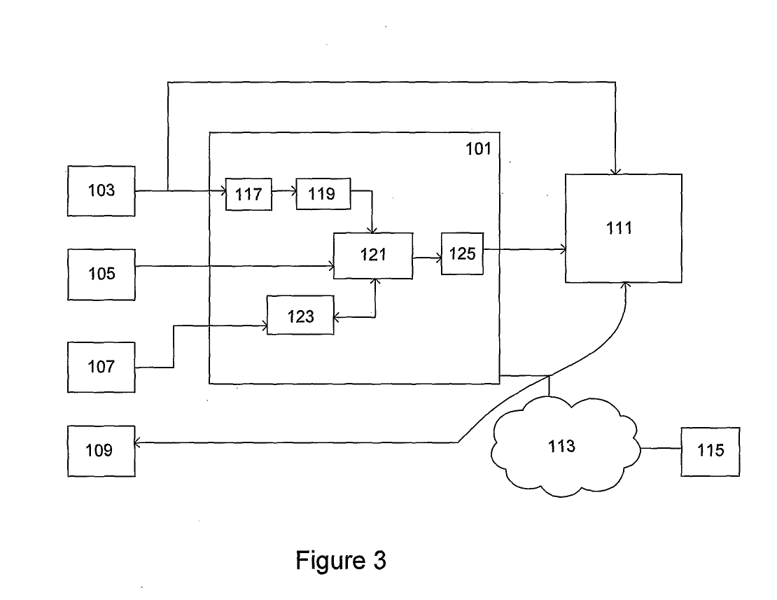

In a further alternative embodiment as shown in FIG. 3, the system is similar as described above with reference to FIG. 1 including any alternatives described. However, in this embodiment, the scheduler 125 does not directly communicate the informational content to the output device but communicates scheduling instructions directly to the output device 111. The output device 111 is in communication with the informational content source 109, which effectively acts as an informational content server. The informational content source transfers the informational content to the output device 111 upon receiving a request from the output device according to the schedule sent by the informational content scheduler 125. Therefore, the informational content may be displayed on the output device with the media content in a similar manner as described in the first embodiment.

In this embodiment, the scheduling instructions include a list of the informational content that is to be displayed on the output device based on the contextual analysis of the media content. For example, the list may identify one or more advertisements for simultaneous output with the media content based on the contextual match. The list may include identification data that instructs the output device which informational content it should request from the informational content source 109. Further, the list may identify the timing or order in which the informational content is to be played. For example, more than one piece of informational content may be placed in the schedule to enable a series of informational content pieces to be output in sequence. That is, the identification data enables the informational content source to identify the relevant informational content from the identification data. For example, the identification data may merely be a reference to a specific advertisement, a reference to specific advertisers or a reference to specific products that are to be played on the output device.

As an alternative to overlaying the informational content over the top of the media content, the informational content may be output on the output device by adjusting the format of the media content as it is being displayed on the output device.

Optionally, the above described embodiments may be adapted so that the media content format is changed to enable the media content and informational content to be displayed on the same screen of the output device. The scheduler may send display control data to the output device, either with, the scheduling instructions or as part of a separate communication. The display control data includes instructions that direct the media content output device to format how the media content is output. For example, where the media content is in the form of a video signal for display as a video image (whether a still image or moving images) the display control data may modify the x, y co-ordinates and size of the image so that the area in which the image associated with the media content is displayed is reduced when compared to its standard display. That is, the media content and informational content are displayed in the media content display area normally allocated for displaying the media content when the informational content is not scheduled.

For example, the image may be reduced in size uniformly across the x and y axes, effectively shrinking the image while keeping it placed centrally on the screen of the output device. This produces an additional display area that surrounds the media content image in the centre. This surrounding area is then used to display the informational content.

It will be understood that the media content image may be modified in various different ways to enable the informational content and media content to be displayed together. For example, the media content image may be minimized along a single axis, such as the x-axis to enable the informational content to the shown at the sides of the media content. Alternatively, the media content image may be minimized along the y-axis to enable the informational content to the shown at the top or bottom of the media content.

According to one particular example, the content is scaled while maintaining the aspect ratio of the original content throughout live transition from full-screen size down to the “windowed” mode. The scaling creates a border along the left or right side as well as the top or bottom, into which the informational content is placed.

It will be understood that scaling could be implemented so that the informational content fits into the centre of the screen, creating a smaller border around the top, bottom, left, and right, framing the media content.

Further, the content may be scaled such that the aspect ratio is not maintained. However, this may be undesirable in certain situations depending on the content of the media content and informational content as images will become distorted.

It is important to note that specific rules may be applied to stop the inclusion of informational content over media content in jurisdictions where broadcast restrictions are in place that forbids this type of media content modification. In this situation, the informational content may only be provided in a manner that does not contravene the restrictions, such as, for example, being displayed around the edges of the media content. Likewise, rules may be applied that stop media content being altered directly in jurisdictions where this is restricted.

Therefore, the media content format may be automatically adjusted or adapted according to the form of the informational content that is scheduled.

By adjusting the format of the media content to enable the informational content to be displayed simultaneously with the media content, a form of forceful advertising takes place that does not interrupt the output of media content.

As a further option, the above described embodiments may be adapted such that the output device automatically adapts or modifies the media content output as soon is it detects that informational content is being played or is to be displayed. For example, upon the output device receiving informational content, the x-axis and y-axis data of the media content is adapted by the output device so that the format of the media content is modified to enable the informational content to be displayed on the same screen.

According to either of the options discussed above, the format of the media content may be automatically reverted back to the original format (i.e. displaying the media content on a full screen) after receiving display control data that instructs the output device to do so, or upon detecting that there is no further informational content being displayed or to be displayed.

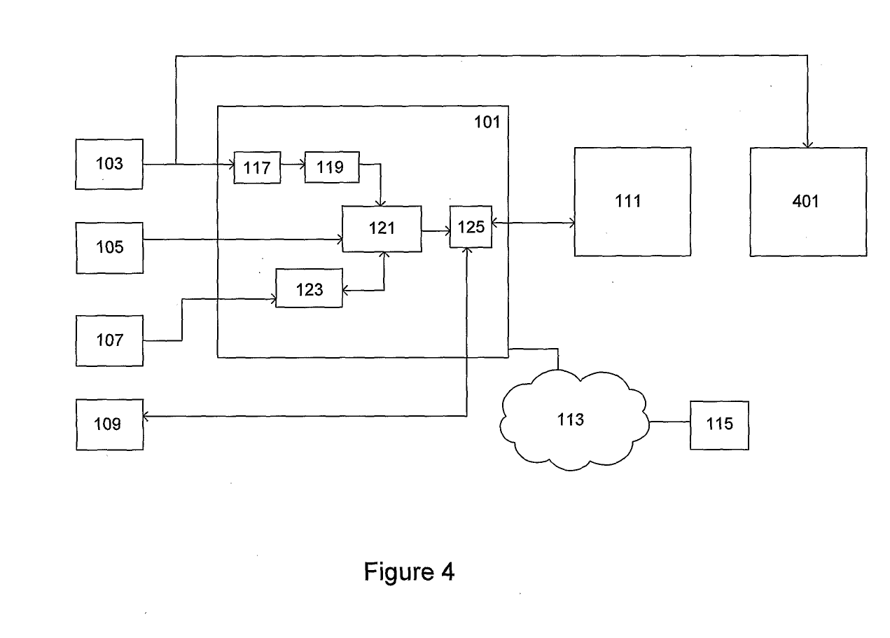

In yet a further alternative embodiment as shown in FIG. 4, the system is similar as described above with reference to FIG. 1 including any alternatives described. However, in this embodiment, the informational content and media content are output on separate output devices. That is, the informational content is output on an informational content output device 111 and the media content is output on a media content output device 401.

The media content output device may be, for example, a television set, video output device, audio output device, multimedia player or any suitable output device that is capable of playing media content.

It will be understood that as the media content output device and informational content output device are separate devices, the media content format is not required to be modified to enable the informational content to be output, however, the media content format may still be modified as described herein to indicate that relevant informational content is being output elsewhere.

The media content output device and informational content output device may also be different type output devices. That is, the media content output device may be a video display device or a television set, whereas the informational content output device may be a speaker system, jukebox or the like. For example, the media content output device may be one of an audio output device, video output device or combination thereof, and the informational content output device may also be may be one of an audio output device, video output device or combination thereof. Any suitable combination may be used depending on the media content and informational content that the user of the system wishes to use. In one particular example, the media content may be a combination of audio and video content, whereas the informational content is in the form of audio content only.

In order for the output of the informational content to coincide with the output of the media content, the informational content output device and media content output device are placed or located in the same area during use. That is, the media content output device and informational content output device are arranged to be within the same localized area when in use such that when an individual receives the media content they are also in a position to receive the informational content in whichever form the content is being output. The same localized area is substantially the same locality (or in the same vicinity) such that both the media content and informational content is conveyed to one and the same individuals. For example, the same locality may be the same room, same area etc.

As an alternative, the informational content output device may be formed as an integral component of the informational content scheduling module. That is, the informational content scheduling module may include a video screen, speaker system or combination thereof to output the informational content directly.

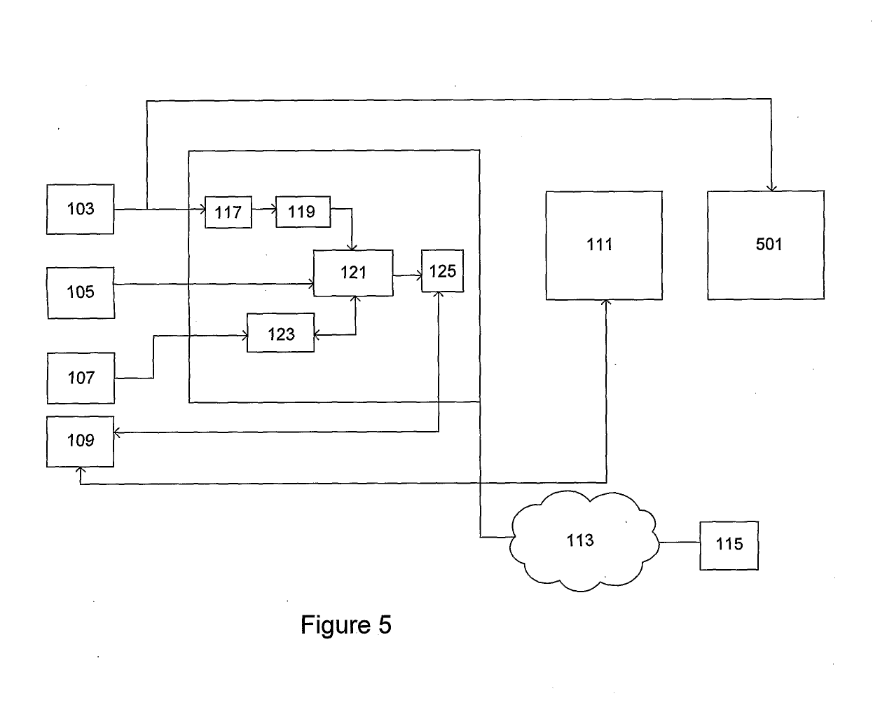

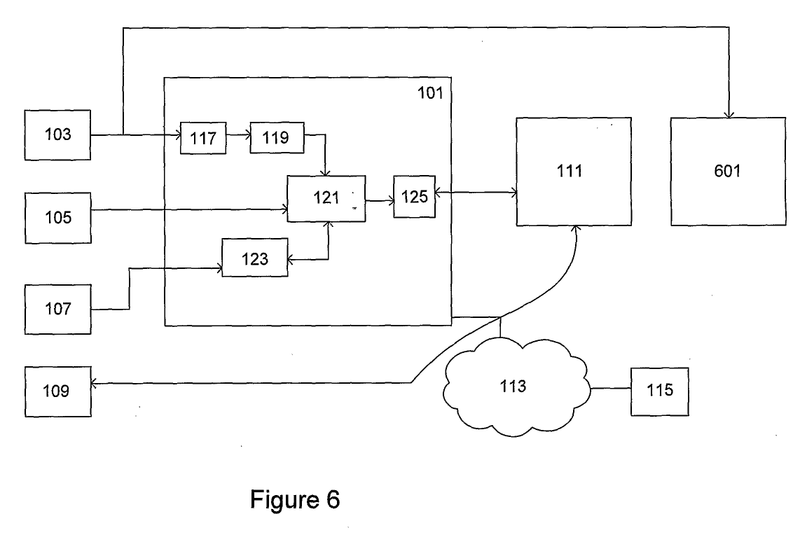

According to further embodiments, and as shown in FIGS. 5 and 6 respectively, the same arrangement as shown in FIG. 4 may be applied to the same system as described with reference to FIGS. 2 and 3.

As shown in FIG. 5, the informational content output device 111 and media content output device 501 are separate devices. Further, the scheduler 125 does not directly communicate the informational content to the output device but communicates scheduling instructions directly to the informational content source 109, which effectively acts as an informational content server. The informational content source 109 transfers the informational content to the output device 111 according to the schedule sent by the informational content scheduler 125 so that the informational content may be displayed on the output device with the media content.

As shown in FIG. 6, the informational content output device 111 and media content output device 601 are separate devices. Further, the scheduler 125 does not directly communicate the informational content to the output device but communicates scheduling instructions directly to the output device 111. The output device 111 is in communication with the informational content source 109, which effectively acts as an informational content server. The informational content source transfers the informational content to the output device 111 upon receiving a request from the output device according to the schedule sent by the informational content scheduler 125. Therefore, the informational content may be displayed on the output device with the media content

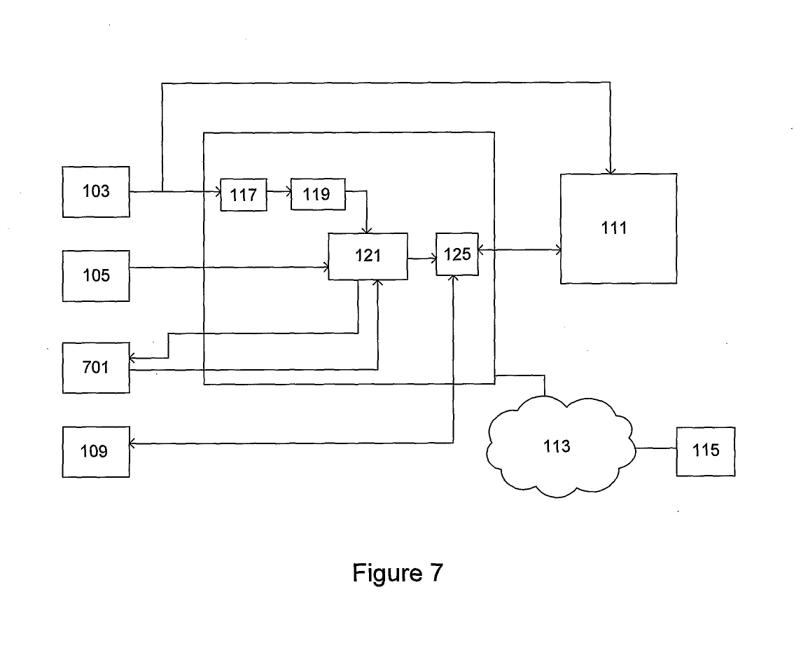

According to a further embodiment shown in FIG. 7, the system as described above with respect to FIG. 1 is used. However, in this embodiment, the informational content context data is not retrieved from an internal storage module, but is stored in an external storage module, such as an external database system 701. After the contextual matching steps have been performed, the correlation module 121 communicates the media content context data to the external database system 701 which finds a correlated match for the media content context data. Upon finding a match, the external database system 701 returns informational content identification data to the correlation engine. The scheduler 125 may then request and retrieve the corresponding informational content from the informational content source 109 and forward the informational content to the output device. It will be understood that the features of this embodiment may be combined with or used instead of the various features of any of the previously described embodiments and options.

The following section describes how the media content may be analyzed by the analysis module 119 to determine the context of the media content.

Various data components within the media content may be detected by the analysis module 119 in order to aid in the determination of the media content context. That is, the media content signal is made up of various different data components, such as, for example, video, audio and closed caption (subtitle) information, each of which either singularly or together can be used to determine the context of the media content.

Further, depending on the form of the media content, the media content may also include other data components (either in addition, or instead of the previous components mentioned) that may be detected by the analysis module in order to aid the determination of the media content context. For example, data identifying the channel being transmitted, such as data tuning data may be captured. As another example, IP header data may be captured to identify the source of data packets. Also, codes inserted or embedded within audio or video media for the purposes of providing identification of context information may be detected. Upon detection, the codes may be cross referenced with a pre-stored set of codes to determine the context or the source of the media. As a further example, media content signatures that are used to identify the media content may be detected and processed to determine the content and its context.

One particular type of data component that the analysis module can analyse is the closed caption data component that forms part of the incoming media content signal. In many countries, closed caption is typically available on the majority of programming on network channels and most of the programs on cable networks. The closed caption data is transmitted on the video feed.

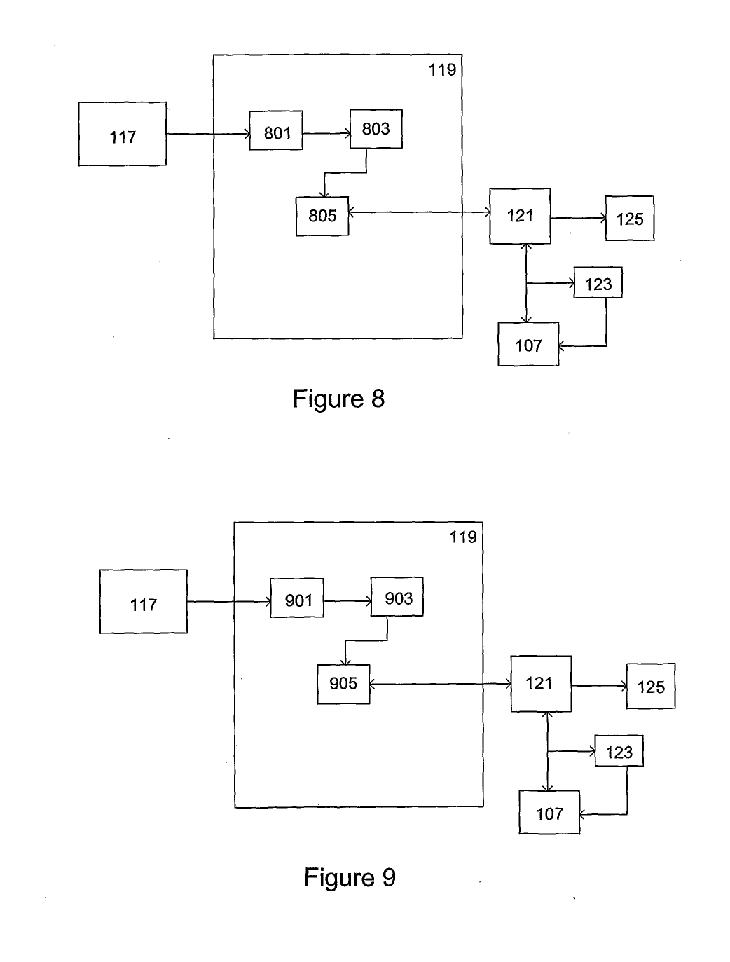

Referring to FIG. 8 details of the analysis module 119 processing steps are provided in relation to processing closed caption data. The closed caption data is detected by a closed caption detection module 801 as the incoming media content signal is received by the receiving module 117. Upon detection of the closed caption signal within the media content signal, the closed caption data is forwarded to a transcribing module 803 that is arranged to transcribe the closed caption data.

The transcribed closed caption data is then forwarded to a parsing module 805 that is arranged to parse the transcribed data to detect key words or key phrases within the transcription.

Any detected key words or phrases are recognized as an identification component which may be used to determine the context of the media content. By using the closed caption information to assign contextual meaning to the media content signal, the informational content can be prioritized so it is played in accordance and in context with the media content that is playing on the screen.

The parsing module 805 is in communication with the correlation module 121. The captured key words or phrases are correlated by the correlation module with key words and phrases stored in the informational content context data storage module. The correlation module accesses various key word values, key phrase values, business rules, media content and informational content contracts, as well as other related data that can be used to correlate media content context data with informational content context data. Therefore, based on the output of the correlation module, the scheduling module 125 schedules informational content to be played on the informational content output device (which may or may not be the same as the media content output device). Alternatively, the correlation module may communicate directly with the database 107 in order to correlate the captured key words and phrases with stored key words and phrases.

It will be understood that this form of closed caption data capture may be applied to any type of media content that includes a form of closed caption data.

Another particular type of data component that the analysis module can analyse is the audio data component that forms part of the incoming media content signal.

Referring to FIG. 9 details of the analysis module 119 processing steps are provided in relation to processing received audio signals. The audio data signal is detected by an audio signal detection module 901 as the incoming media content signal is received by the receiving module 117. Upon detection of the audio signal within the media content signal, the audio data is forwarded to a transcribing module 903 that is arranged to transcribe the audio data.

The transcribing module 903 may have incorporated therein a voice recognition module that enables the transcripts to be created from the incoming audio in the absence of closed caption data. For example, video feeds that may not carry closed caption data include sources such as DVD, YouTube or other media produced specifically for a medium where closed caption is not required. Therefore, captured audio may be translated into a readable text transcript

The transcribed audio data is then forwarded to a parsing module 905 that is arranged to parse the transcribed data to detect key words or key phrases within the transcription in the same manner as described above for the closed caption data.

Any detected key words or phrases are recognized as an identification component which may be used to determine the context of the media content. By using the audio data to assign contextual meaning to the media content signal, the informational content can be prioritized so it is played in accordance and in context with the media content that is playing on the screen.

As in the case of the closed caption data analysis, the parsing module 905 is in communication with the correlation module 121. The captured key words or phrases are correlated by the correlation module 121 with key words and phrases stored in the informational content context data storage module 123. The correlation module accesses various key word values, key phrase values, business rules, media content and informational content contracts, as well as other related data that can be used to correlate media content context data with informational content context data. Therefore, based on the output of the correlation module, the scheduling module 125 schedules informational content to be played on the informational content output device (which may or may not be the same as the media content output device). Alternatively, the correlation module may communicate directly with the database 107 in order to correlate the captured key words and phrases with stored key words and phrases.

It will be understood that, as an alternative, the audio data may be detected at a point other than at the point of receipt from the receiving module. For example, the audio data may be extracted from within the media content after the media content has been received by the media content output device. Alternatively, the audio data may be retrieved by detecting the audio data from audio output signals received by an audio capture device, such as a microphone, positioned near the media content output device arranged to play the media content.

Another particular type of data component that the analysis module can analyse is the video data component that forms part of the incoming media content signal.

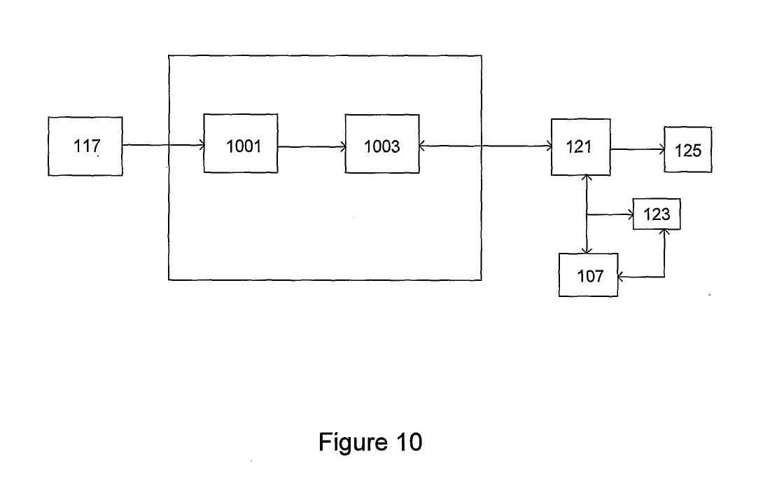

Referring to FIG. 10 details of the analysis module 119 processing steps are provided in relation to processing received video signals.

The analysis module 119 includes an image capture module 1001 that is used to capture key images from the incoming media content. For example, still images may be captured at regular intervals from the media content as it is received by the receiving module 117, and each still image analyzed to determine what identification components are located within the image.

Alternatively, the streaming images may be continually monitored to detect specific identification components. For example, if the image capture module detects that a particular image has appeared more than a pre-set number of rimes within a specific time period, that image may be captured and analyzed. Alternatively, if the image capture module detects that a particular image has appeared continuously in the media content for at least a specific pre-stored period of time, that image may be captured and analyzed.

Any suitable known image capture technology may be used to carry out the tasks of capturing images. For example, a standard video camera or webcam may be used. Further, an analogue-to-digital video capture device may be used to accept a standard or high definition television signal over RF. Further, other forms of signal such as Composite, S-Video, Component, for example may be captured by using the appropriate cabling. Further, a digital video broadcast may be received directly from a device or network. Further, video files may be processed by the system.

Where the image capture module 1001 is used to monitor incoming media content, the image capture module may be programmed to detect one or more key images that are associated with informational content that is arranged to be scheduled.

The analysis module 119 further includes an image matching module 1003 that is used to determine whether the captured key image is relevant. That is, using the correlation module 121, the captured image is compared with known images stored in a database 107. If it is determined that the captured image matches the stored image, then informational content associated with the stored image can be identified.

For example, if the image detected is a particular brand's logo, then upon matching that logo to a stored image in the database 107, the associated informational content for that logo, or data identifying the informational content, may be retrieved from the database for use by the scheduler. The data identifying the informational content may be of any suitable form, such as a database reference, text string or tag associated with the informational content.

Alternatively, the image matching module 1003 may produce a text string that identifies the key image. For example, the key image may include a portion of text associated with a particular brand, theme, program or the like. Once the portion of text has been detected by the image matching module 1003, the database 107 may be queried, or the informational content context data storage module may be queried, to determine the relevant informational content associated with the key image.

Alternatively, the text detected in any images may be transcribed and parsed in a similar manner as described above in order to determine identification components within media content.

Therefore, image recognition may be used to capture logos, brands, or visual cues that will allow the system to more accurately contextualize the type of content being played. Image recognition will also capture contextual cues in the absence of audio and closed caption feeds. Depending on cabling configurations, receiving technologies and audio capabilities, the absence of audio and the absence of closed caption feed may be quite common, particularly in the area of digital signage.

Much like closed caption and audio functionality a database is created to assign meaning and value to common images. Examples of images would include logo's such the CBS ‘eye’, the NBC ‘peacock’, ESPN, CNN or FOX. The system has the capability of recognizing common brands symbols such as those used for TARGET, PEPSI and CHEVROLET. The system may capture these images and translate them into a text value to be compared against the database. These meanings will allow the correlation module to assign values to the content being displayed (media content) so that informational content can be prioritized in accordance with business rules and media contracts that are also stored in the database.

Image recognition also provides a solution for a problem that exists between digital signage advertisers and commercials that already exist within a broadcast feed. Multiple digital signage software vendors have solutions that allow advertising content to be overlaid on top of or wrapped around a broadcast signal or video feed. One concern for potential advertisers is the possibility of ‘ad on ad’, or their branded asset being played during a commercial for one of their competitor's products. The image recognition steps described herein allow the system to detect when advertising content is being played and when the video playing is a television show or other televised event. The system will search the incoming video feed for certain cues like logos or images that do not change for a predetermined time frame. Depending on what the system is programmed to seek out in the video stream the informational content scheduling module can identify what is being displayed on the screen. Therefore, to avoid an ‘ad on ad’ situation with conflicting advertising strategies, the rules for a certain advertiser may be adapted so that advertisements for the advertiser's brands are directed to be scheduled only during the televised event and not during commercials.

The various steps described above in relation to detecting the context of media content may also be applied to detecting the context of informational content. That is, prior to informational content being made available for output on an informational content output device, the informational content is analyzed to determine its content and to associate tags with the content.

For example, the informational content may be received from an informational content provider, such as an advertiser. The informational content may then be processed using the above described methods to detect the video, audio or closed caption data within the informational content and to identify key elements. By detecting the various identification components that form informational content context data, whether key words, key phrases or key images, the informational content may be categorized and assigned relevant contextual tags to enable the informational content to be contextually matched with the media content at a later time.

The informational content may be tagged with one or more various tags such as, for example, #sport, #tennis, #score, #goal, #pepsi logo, #coca cola logo, #CNN channel, or a multitude of other descriptive type tags depending on the context of the informational content.

For example, an image capture module may also be used to monitor new informational content in order to identify key images that identify the context of the informational content and that are likely to appear in media content. For example, the image capture module may be arranged to detect specific logos or images from a database of known logos and images associated with a large range of informational content. Once detected, these specific logos or images may be stored in a database 107, and the informational content tagged to form informational content context data, so that later analysis of media content enables identification components that are similar to the stored logos and images to be identified.

The following describes an example data structure for use in an SQL database.

CREATE TABLE keyword_group (

| | | | |
|---|---|---|---|
| a. | keyword_group_id | int4 | primary key, |
| b. | name | varchar(256) | DEFAULT NULL |
| ); | | | |

CREATE TABLE keyword_group_entry (

| | | | |
|---|---|---|---|
| c. | keyword_group_entry_id | int4 | primary key, |
| d. | keyword_group_id | int4 | references |
| | | | keyword_group, |
| e. | keyword | varchar(255) | DEFAULT NULL, |
| f. | positive_matching | Boolean | DEFAULT ‘t’, |
| g. | weight | int2 | DEFAULT NULL, |
| h. | frequency | real | DEFAULT NULL, |
| i. | total_count | int4 | DEFAULT NULL |
| ); | | | |

A single channel or piece of content may be assigned a single keyword group. Each keyword group may have zero, one, or multiple entries linked to it.

For each entry:

An individual word or phrase may be stored in the “keyword” field.

A “positive” (or “negative”) matching can be ascribed. For example if the system is matching keywords to the “CNN” channel, the keyword “cnn.com” may have a positive matching set to true, but “espn.com” set to false.

A “weight” is given which equates to a specific point value to be used when calculating a match. This value may be automatically determined or manually configured.

The “frequency” of this specific keyword is tracked in order to provide a point value when a weight has not been set.

The “word count” refers to the total number of instances a given keyword has been detected in all scans related to the entry. By enabling the system to track both this figure as well as the frequency, any duplicate entries can be merged (such as moving a word or phrase from two channels into the “common words” registry) in such as way as to maintain the exact frequency versus all words detected, instead of taking a simple average. For example if the word “weather” appeared 20 times out of 100 words total scanned (20% frequency) for CNN and appeared 10 times out of 80 words total scanned (12.5% frequency) for ESPN, the two frequencies averaged would be 16.25%, but the actual frequency would be 30 times out of 180, or 16.66%. This margin of difference may become very important as the dictionary of all words grows larger.

The same data structure discussed above may be used for both tagging content and matching content, whether performing either action manually or automatically.

For example, through a web-based interface, a user who wanted specific informational content to appear when the topic of “Tennis” is detected (in a conversation, in a video feed, through a Closed Caption transcript, etc.) but never when CNN is present in the vicinity, may manually enter tags such as:

j. tennis+3, espn, racket, court, tennis ball, match, !cnn−3, !cnn.com

In this example, the “!” symbol indicates “not” for positive matching, the “+3” and “−3” both indicate a weight of 3, etc.

Alternatively, the informational content may be manually analysed by a trained analyst to identify identification components within the informational content and the analyst may manually assign tags associated with those identification components to the informational content for later contextual matching with the media content. For example, when the analyst determines that the informational content is associated with a drug for reducing pain, the tag #painkiller is associated with the informational content.

In each of the examples where video, audio or closed caption data is being analyzed, the data may be analysed utilizing a rules engine. The rules engine may form part of the analysis module, correlation module, or both. The rules engine accesses a set of rules that indicate when a detected identification component is considered to be a key identification component that forms at least part of the context data of the informational content or media content.

The rules engine may, for example, instruct the analysis module to disregard all common words, phrases and images as identification components and only use specifically listed identification components.

As a further example, the rules engine may have access to a list of known brand logos, phrases or slogans that may be detected as an identification component, such as the Pepsi and Coca Cola logo, or the phrase “True” for Budweiser Beer.

As a further example, a combination of different words or phrases may be looked for by the rules engine in order to detect an identification component. For example, upon detecting the words “head” and “pain” within a few words of each other the rules engine may output a decision that a painkiller advert is relevant. Therefore, if it is media content that is being analysed, an advert for a suitable painkiller may be scheduled by the scheduler 125. If it is informational content that is being analyzed, the advert may be associated with the tag #painkiller.

Also, in each of the examples provided above where video, audio or closed caption data is analyzed, weight values may be assigned to the detected identification components. The weight values provide a scaled method of:
i) identifying tags that are to be associated with the informational content or
ii) contextually matching media content context data with informational content context data in order to schedule informational content.

Optionally, the detected identification components within the media content may be analysed by a rules engine to identify a theme, media channel or media program, for example.

The rules engine may form part of the analysis module, correlation module, or both. Upon detection of the theme, media channel or media program, the rules engine may limit the informational content context data to a sub-set of informational content context data that is only associated with the detected theme, media channel or media program. The sub-set of informational content context data is then made available to the correlation module for it to correlate the informational content with the media content.

According to one example, the detected identification components enable the rules engine to determine which specific program channel is being received through the detection of specific logos, words or phrases, as defined in the pre-stored rules.

For example, the media content closed caption data being received may be analyzed to determine the channel. The media content input to the informational content scheduling module may be monitored over a pre-set period of time, and all the detected identification components within that period of time may be analysed to determine the specific channel. The detected identification components may be allocated a weighting value or points value associated with various channels, and as such, once the detected identification components have been analysed, the rules engine is able to make a determination as to which channel is most likely being received based on the weighting and/or points values allocated over a set period of time.

Upon detecting that the media content is related to a specific program channel, informational content context data specifically for that channel is used by the correlation module to correlate the media content with informational content. In this way, the speed of correlation processing is increased and made more accurate. For example, if the program channel is detected to be a sports channel, the informational content context data may be limited to a subset of data that only includes relevant identification components associated with sporting products or events.

It will be understood that the same or similar process may be applied for detecting specific themes in the media content as it is received, or for detecting specific themes in informational content as it is analysed for the purpose of allocating tags.

Further, it will be understood that the same or similar process may be applied to detect specific programs within the media content, or to associate specific programs with informational content.

It will also be understood that the various techniques discussed above may be used to determine which informational content is not to be played with the media content. That is, various items of informational content may include one or more tags that identify that the informational content should not be played when specific identification components are detected in the media content. For example, if it is detected that the media content is from a CNN channel, the pre-stored rules utilized by the rules engine may specify that other news channel informational content is not to be shown under any circumstances, even if there is a contextual match. In a further example, an event may be broadcast that is sponsored by a large drinks manufacturer, such as Pepsi for example. The rules engine incorporates pre-set rules that inform the scheduling module that no informational content associated with rival drinks manufacturers, such as Coca Cola is to be broadcast.

Another potential input to the informational content scheduling module is ambient data. Ambient data may take the form of ambient audio or ambient video.

Where the ambient data is ambient audio, a microphone, may be placed near the media content output device that is arranged to output the media content. The microphone can be used to capture conversations and dialogue from other displays with audio capabilities, or direct comments and commands received from individuals. Much like the analysis of the audio feed from the media content as described above, this ambient audio data can be captured and pushed through voice recognition software to detect key words or phrase. The system will take the audio feed, translate it into a transcript and search that transcript for keywords that correspond with informational content that is stored on the media player. Informational content that pertains to the ongoing conversation or ambient audio may then be elevated to the top of the playlist by the scheduler.

Further, this technology could be used to intentionally influence the display of a particular screen controlled by a media output device incorporated in the system. Visual and textual cues may be presented on the screen of the media content output device to enable a person observing the screen to call up menus or additional information simply by speaking commands. A microphone set up to collect the ambient or ‘direct’ audio transfers the commands to the scheduler via the audio capture and parsing modules to drive the media content and informational content that the media player sends to the screen.

Further, in a similar way to the capture of ambient audio, the system may include the capability of additionally or separately capturing ambient video in the form of images by utilizing a camera device. For example, with the use of the camera device, images of a particular environment could be captured and analyzed to determine user characteristics such as crowd size, crowd movement (e.g. passive or active) and position of individuals (e.g. triggering ancillary media to be played depending on a person's proximity to a screen or speaker). Even gender may be determined from ambient audio or video information for analysis and weightings by the rules engine.

Various other consumer or user data, i.e. data associated with the consumer or user may be used. This may include age, gender, location, as well as details of programs previously watched on the media content output device, etc.

Another factor that may be used to determine how or which informational content is to be output is the location of the output device used to output the informational content (whether this is the same as the media content output device or a different device).

The system incorporates location information devices to enable location relevant informational content to be output on the informational content output device.

If the informational content output device is being used in a fixed location, the system may identify location information through back end systems. That is, the back end systems can identify specific informational content output devices and determine from the identification of those devices their location. For example, a database (or other suitable data storage module) may be used to store details of the location of all known informational content output devices. Upon retrieving identification data that identifies the informational content output device, the database may be queried to determine the location. Alternatively, the signals received from an informational content output device may provide data that shows the location of the informational content output device.

According to a further example, if the informational content output device is a mobile communication device, such as a mobile telephone device, data identifying the location of the device may be retrieved from a GPS (Global Positioning Satellite) unit from within the mobile communication device. Alternatively, the location of the device may be determined from another location information source, such as a telecommunication service provider providing telecommunication services to the mobile communication device. For example, the service provider may use triangulation techniques to determine the location of the device.

It will be understood that various other techniques may be implemented to determine the location of the output device depending upon the form of the output device and its communication methods. For example, if the informational content output device is connected to the Internet, router information and IP addresses may be used to determine the location of the device.

As a further example, upon detecting specific channels or programs being output on the media content output device by analyzing the media content using the methods as described herein, program scheduling information associated with the media content may be retrieved and analyzed to determine where those detected channels or programs are being played. That is, the system monitors program schedules to see where the determined media content program is currently being output, and based on any identified matches, the channel can be determined. Based on the determined channel, one or more potential locations may be determined. The location of the media content output device may therefore be determined and used to schedule the informational content.

According to a further example, ambient audio or video data may be captured at the informational content output device, and the ambient data may be analysed as discussed herein to determine the location of the device. That is, key elements, such as key images, key words or phrases may be detected as being associated with a specific location. For example, the audio capture system may detect the name of a local sports team in a conversation.

Once the location has been determined, the informational content may be scheduled based on the location information. That is, informational content associated with a specific location or area may be scheduled, or informational content associated with a different location or area may be specifically removed from the schedule. The location information may be used in conjunction with the media content context data to schedule informational content based on a pre-stored set of informational content insertion rules.

It will be understood that the image recognition techniques described above may also be used as a part of the location identification process. The location information may be used as part of the informational content tagging process so that informational content may be scheduled according to specific locations. For example, logos of local sports teams, network logos, etc may be referenced against a broadcast schedule to validate location. By utilizing specific rules in the rules engine, various pieces of informational content may be scheduled based on the determined location. In addition to the image recognition techniques discussed herein, other cues such as lighting, audio cues, and keywords identified in a closed caption feed can also be used to by the system to determine location using similar analysis techniques as described herein.

The location information retrieved may optionally be analyzed with respect to a pre-stored set of location data held by a third party.

The informational content scheduling module may optionally base the scheduling of informational content on information received from content based sources.

For example, content based sources may include a weather content source, a news content source, a financial content source, an entertainment content source or a sports content source, for example.

Upon detecting within selected sources that a relevant event has occurred, the contextually relevant informational content may be scheduled based on the defined scheduling rules.

For example, the informational content output device may play a recommendation for sunscreen SPF or fluid consumption based on weather information provided from an RSS feed from a weather website. As a further example, stock market status information could be used to influence whether or not advertisements for high end products are played, or, in the event of a down turn in the market, whether recommendations for a safe place for investors to put their money is advertised.

In addition to the media content context data that is captured from the media content as it is received by the informational content scheduling module, the system may also include further data for analysis to determine how informational content is to be scheduled.

Informational content usage data, such as, data retrieved from informational content contract details on when, where, what and how individual informational content may be displayed can be used.

The informational content usage data may be stored in a database or storage module along with the informational content or the informational content context data. The informational content scheduling module may retrieve the informational content usage data in order to schedule the informational content based on the media content context data that is determined.

For example, the media content may be analysed to determine the context data associated with the media content. The context data may include a combination of a contextual meaning output that identifies the contextual meaning of the media content as well as a weighting value that indicates how much weight is to be applied to the context data. The weighting value may be used to affect how, or indeed whether, the informational content is scheduled. For example, a positive or negative weighting may be applied for various informational content such that a positive weighting increases the chances of the informational content being output, and a negative weighting decreases the chances of the informational content being output.

The contextual meaning output and weighting values may be determined by retrieving the relevant contextual meaning output and weighting values from a database by querying the database with the media content context data.

By utilizing a set of pre-stored scheduling rules, the system may schedule the informational content based on the informational content usage data, contextual meaning output and weighting values. The pre-stored scheduling rules may be used to affect at least any one of the start time, end time, duration, frequency, manner of display or type of the scheduled informational content to be output.

The various embodiments of the herein described system may be managed via the web interface. Key elements can be created and assigned values in the database. Developed informational content can be manually scheduled to play at anytime regardless of keywords. Also informational content output devices can be controlled independently or as part of larger groups.

Additional interfaces may include touch screens integrated into a display to schedule content or change the pre-stored rules. Remote controls or mobile phones may also be used to control content changes as well.

Scheduling and playing informational content dynamically may require the monitoring and reporting of informational content output. For example, the system may be used to demonstrate how many times a particular advert was played and what exactly prompted the advert to be displayed. It may be relevant to not only distinguish what type of cue triggered the advert, such as image, voice, or closed caption, but also what the specific key element was itself. The reporting system may be built into the informational content output device application. Third parties will also provide their own reporting mechanisms that communicate with the scheduling system.

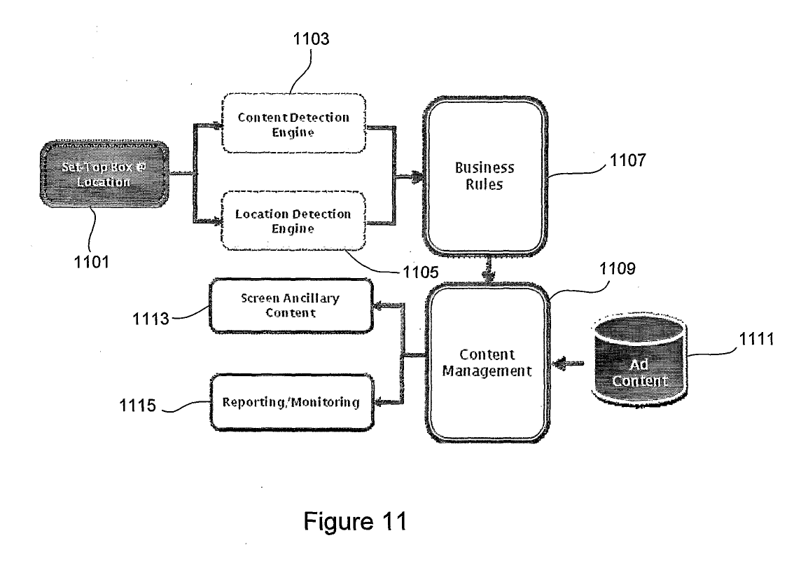

FIG. 11 shows a conceptual block diagram of an informational content scheduling system according to an embodiment of the present invention. An informational content output device 1101, such as a digital signage system, provides media content to a content detection engine 1103 and a location detection engine 1105. These two engines provide the detected content/context and location information to a rules engine 1107. The rules engine determines which informational content is to be scheduled and instructs a content management module 1109 to retrieve the identified informational content from an informational content server 1111. The content management module 1109 then outputs the scheduled informational content as ancillary screen content. Further, a reporting module 1115 provides reports on the informational content that has been scheduled.

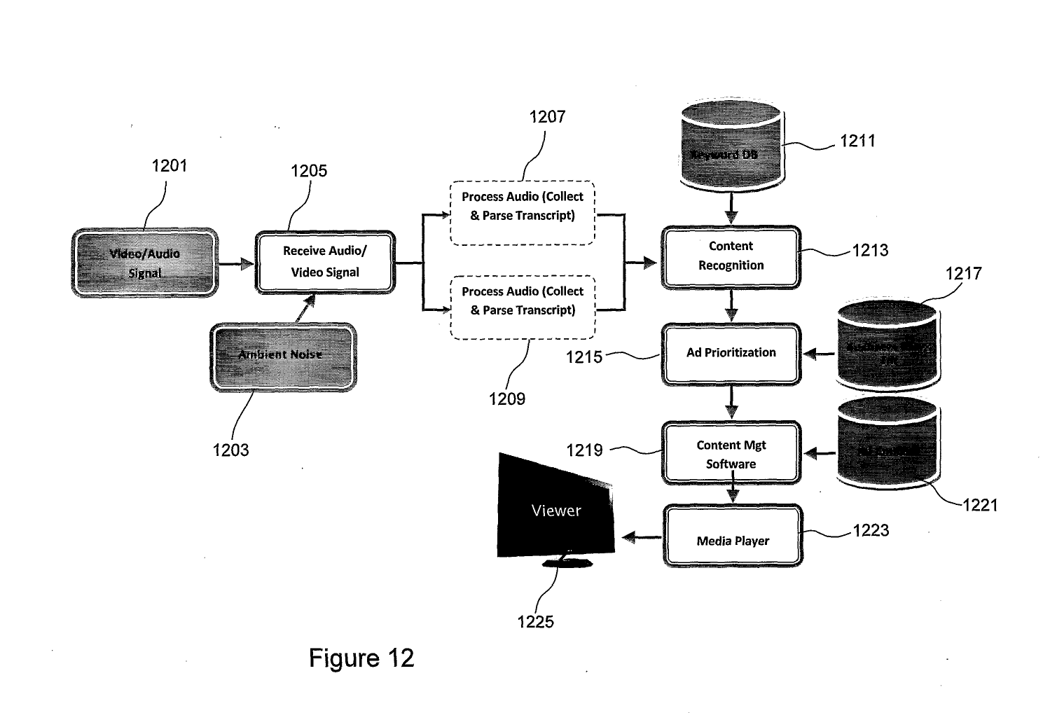

FIG. 12 shows a conceptual flow diagram of data according to an embodiment of the present invention. An AV (audio visual) signal 1201 and ambient noise signal 1203 are received at an AV signal receiver 1205. The audio component of the AV signal 1207 and the audio component of the ambient noise signal and processed (i.e. transcribed and parsed). By utilizing a pre-stored set of key elements in a database 1211, content recognition 1213 takes place. The informational content prioritization or scheduling occurs 1215 based on a set of pre-stored rules available from a database 1217. A content management module 1219 retrieves the relevant informational content from an informational content server 1221 and forwards it to a media player 1223, which in turn enables the media content to be displayed on a viewing device 1225.

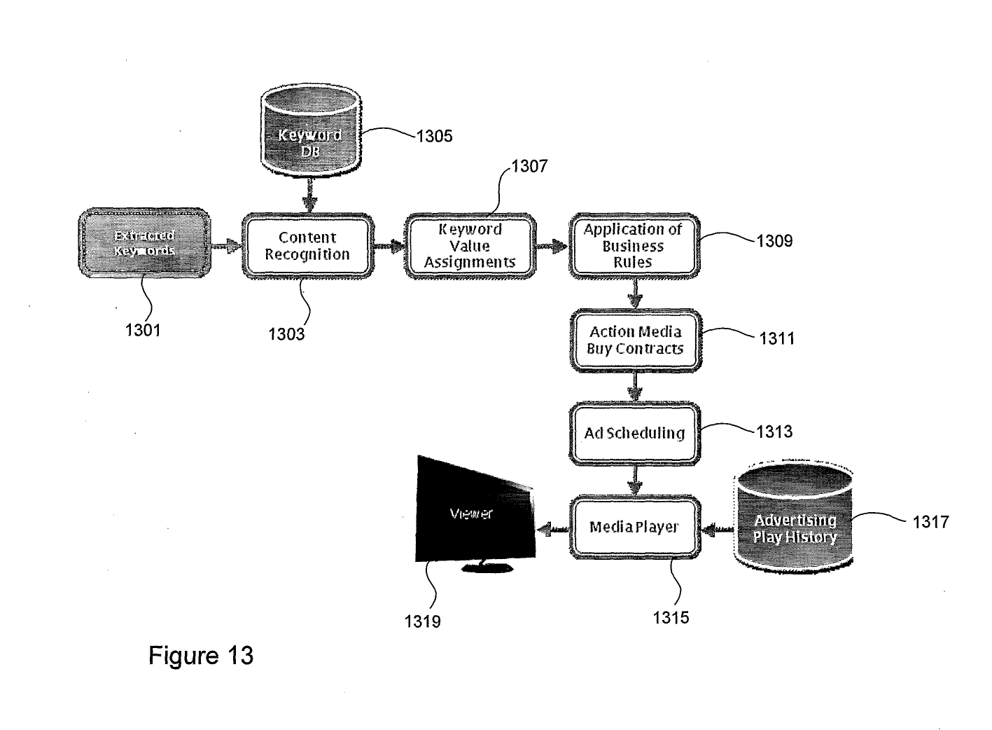

FIG. 13 shows a further conceptual system diagram according to an embodiment of the present invention. Extracted key elements 1301 (such as key words) are forwarded to a content recognition module 1303, which utilizes a set of pre-stored key elements available from a key element database 1305 to recognize the extracted key elements. A key element value assignment module 1307 assigns value to the key elements in the form of weight values. A business rules module 1309 applies a set of pre-stored rules to the valued key elements. A contract module 1311 retrieves stored contract data 1311 to aid the scheduling of the informational content, and forwards the data to the scheduler 1313, which utilizes the rules and value assignment data to determine a schedule. A media player 1315 outputs the informational content on a viewer 1319 and the history of informational content output is stored in an informational content history database 1317 in order to monitor and collect the relevant revenue associated with the informational content output.

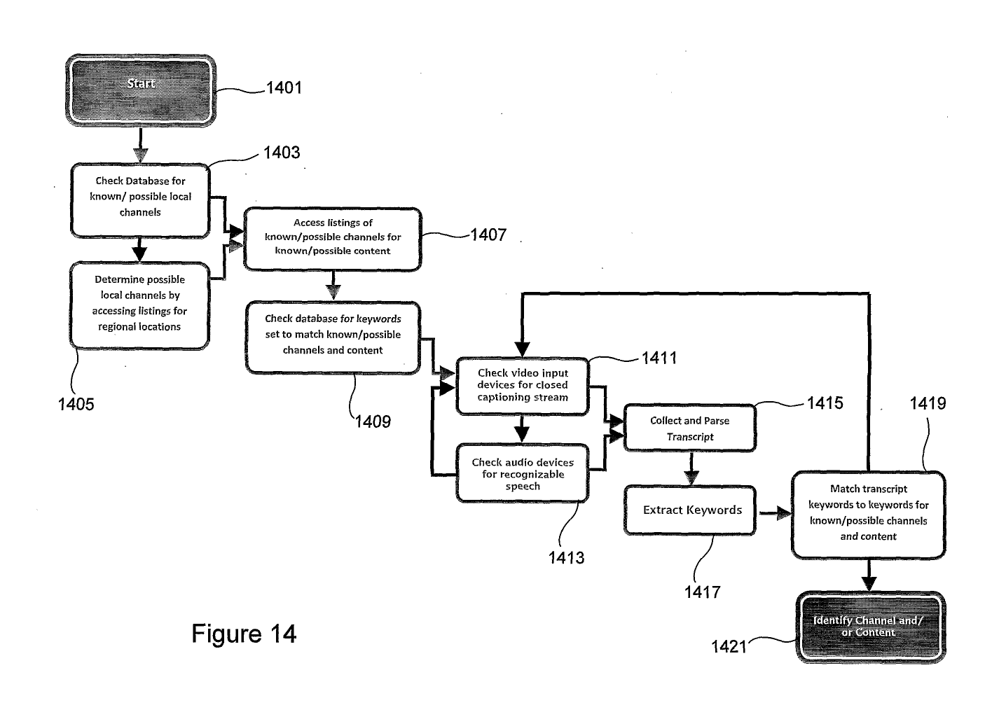

FIG. 14 shows a flow diagram of a channel detection method according to an embodiment of the present invention. After starting 1401, a database is checked to search for known or possible local channels at step 1403. At step 1405, possible local channels are determined by accessing listings for regional locations. The outputs from steps 1403 and 1405 are used to access listings of known or potential channels for known or potential content at step 1407. At step 1409, a database is checked for key elements (such as key words) that match the known or potential channels and content. At step 1411, the video input is monitored from closed caption streaming. At step 1413, audio devices are checked for recognizable speech. The outputs of steps 1411 and 1413 are collected and transcripts parsed at step 1415. Keywords are extracted at step 1417, and transcript key words are matched with keywords for known or potential channels and content at step 1419. The channel is then identified at step 1421 based on the matching step.

The system therefore incorporates a channel detection module that can have two modes of operation, a scanning mode and a detection mode.

In the scanning mode, a specific channel is tuned in to the channel detection device. The specific channel identification is also provided to the device. Each word or phrase which comes through the device is processed. If the device has not processed the word or phrase before, an entry is added to a database, and is ascribed to that channel (using the channel identification). If the word has been processed previously by another channel, the new entry and the other channel's entry are both merged into a table of “common” words.

The exact frequency, relative to all words seen, of all words and phrases scanned into the database is also tracked by the device.

In a detection mode, the device is not aware of which channel is being monitored. Each word and phrase the device receives is matched against the “common words” table first, and then successively matched against entries for each channel previously scanned. Any matches to common words are ignored or discarded by the system.

Any determined matches to words which have only been seen on a specific channel are assigned a point value which is added to or subtracted from a running total for all known channels. As points are allocated they are time stamped such that they can be set to expire from the running total after a preset period. This facilitates faster detection times following a change of the current channel. Once the point value for a single channel surpasses a pre-stored threshold above the value of any other channel, that channel is determined by the system to have been “detected.”

The point value is related to the frequency which that word occurs on a given channel. The more frequently it occurs overall (but only on a specific channel), the higher the point value. Optionally, high frequency words from one channel, when received, can be used to lower the point value of another channel.

For example, if the system is arranged to detect CNN news and ESPN sports versus any other channels, the word “reporter” might carry one point for CNN and no points for ESPN, but “cnn.com” might carry three points for CNN and negative three points for ESPN.

Once a new detection occurs, the rules engine is accessed by the device to determine an appropriate action to take. For example, rules may include forbidding certain content to display so long as that specific channel is determined to be detected, or forcing certain content to display immediately.

It will be understood that various other forms of the channel detection algorithm may be used as an alternative.

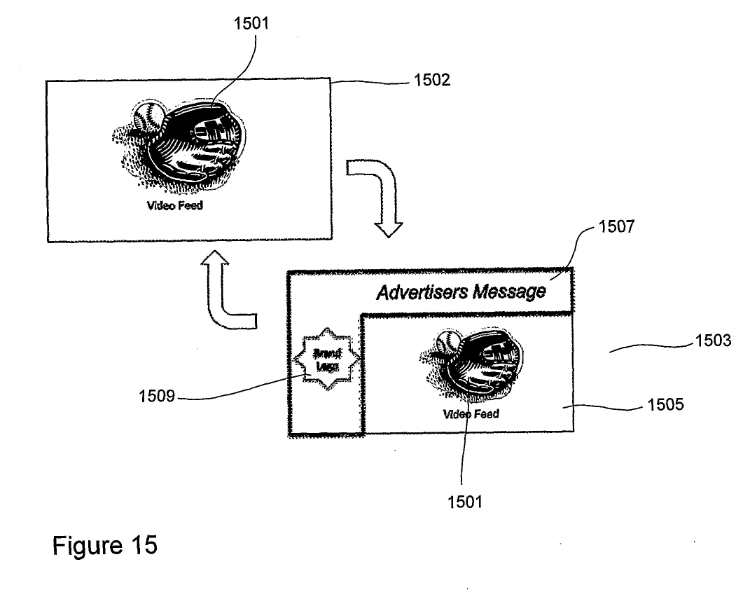

FIG. 15 shows a conceptual view of how media content may be adapted to enable informational content to be simultaneously displayed according to an embodiment of the present invention. Media content 1501 is displayed according to a standard first mode 1502 where only media content is displayed (i.e. no informational content is displayed with the media content). When informational content is scheduled, the format of the media content is modified so it is displayed according to a second non-standard mode 1503. That is, the media content area of display 1505 is reduced to enable informational content 1507 & 1509 to be inserted in, for example, the form of an advertiser's message 1507 or brand logo 1509. Once the informational content has finished being displayed, the media content format reverts back to the standard first mode 1502.

According to embodiments of the present invention the operating system may be implemented using a software solution that is hardware agnostic. The solution may be configured to work with Linux based media players. Media players may also be PC's, satellite/cable receivers, or proprietary, custom developed technologies that run on but are not solely limited to the Linux Operating System.

The applications as described have been developed to run on Linux based PC's and media player devices, but it will be understood that other media player devices may be incorporated or used as alternative.

The herein described system may use multiple capture devices that are capable of capturing video and audio streams from a source. The primary capture devices that may be used with the herein described technology are television capture cards, microphones and cameras.

The key element database will be populated and a master database may be managed by a supervisory company. The database may be used to evaluate the meaning and value of keywords or images (translated to a text string), informing the prioritization engine of what types of ancillary content should be played. Replica databases may be stored on independent media players, which can then be controlled or customized on an independent level or be managed as part of a larger group.

Various embodiments of the system as described may be used in a wide range of applications, as a comprehensive software suite, in the digital out of home industry. This system is especially conducive to use in the advertising space, but its potential usage goes beyond this industry. Some potential configurations and applications are discussed below.

Informational content (e.g. adverts) may be played in a partial screen surrounding media content (e.g. video content). Video content could be in the form of a DVD feed, broadcast television, mpeg files, .mov files etc. Adverts may be scheduled based on the engine to slide into the frame for a predetermined length of time leaving the actual video signal undisrupted.

Full screen adverts may be played in as still images, videos, or as plain text. Adverts can be scheduled based on images or audio feed of files playing on the media player. If audio is played using a separate system audio may be captured using a microphone set up and engaging the voice recognition application

The Audio may be independent of screens—The technology may be implemented for audio only environments. For example, a gym or waiting room using some type of radio or IP based media player to play audio for patrons or customers to listen to, could implement this technology to play contextually relevant messages based on the primary media or ambient sounds or images.

Advertisements may be played as flash files, video files or still images, for example. Adverts can be full screen or partial depending on the configuration. Full screen adverts can have complete audio capability as long as the system is set up accordingly. Partial screen adverts may have the capability to play files with audio however this functionality may only be used in cases where the main screen is not utilizing audio, and audio capabilities exist.

This system may also be used to display informational messages such as alerts or advisories. Advisories can be created manually or keywords could be reserved to prompt such advisories.

Partial screen functionality may be used in an information manner as well. The system has the ability to reserve any part of the screen to display customized messages based on keywords. This space may be used to display schedules, whether information or helpful information based on keywords coming through in the video/audio feed.

The described technology is extremely well suited for use in dynamic advert placement in public venues. Embodiments of the present invention may be utilized in any setting where there is a desire to attract viewer attention with content that is delivered based on, for example, location and context of media or ambient audio. Below are a number of illustrative examples of environments that are well suited for contextual advert and content placement:

Embodiments of the present invention may be used to prompt informational or advertising content in airport or similar transportation terminal (buses, trains, etc.). Ambient noise can be captured from casual conversations, audio from TV's on the premises, from airport announcements. From an advertising standpoint it is very attractive for an advertiser to be able to have their ad displayed when it can be closely tied or related to a topical conversation, or other audio cues that might be present within the surroundings. Similarly, embodiments of the present invention can be used to textually and graphically display important information that is being broadcasted through the airport over the public address system. Supporting these audio messages with text on screen helps the message get across to those engrossed in conversation, talking on the phone, or listening to music on a headset.

Textual prompts have a special value in gyms or any other location where many, if not most, of the patrons are wearing headsets that prevent them from hearing audio advertising. Most gyms do use broadcast television to entertain members while they are working out. The contextual placement engine allows the capture of information from video. Depending on the programming, adverts may be played to a fitness focused consumer, watching a specific program, in a specific place. This detailed level of demographic is attractive to advertisers as it allows them to know exactly whom they are delivering their message to.

Similar to gyms sporting venues offer the opportunity to deliver a message to a bunch of likeminded consumers. Although video and audio programming in a sporting venue is relatively predictable, the density of people present in these locations creates a unique opportunity to capture ambient audio. Typical sporting venues have hundreds if not thousands of screens per location, presenting many opportunities to deploy this type of technology. Sporting venues also derive a tremendous amount of revenue by selling things like food, drink and souvenirs so the ability to effectively drive incremental sales could more than justify the investment in this technology.

Golf courses and country clubs often have events, promotions or information that they want to convey to convey to their patrons or members. For example a golf course may be looking for a way to promote an upcoming tournament or a country club may want to notify its members of upcoming events. Often in these locations, the types of events that they hold cater to men or women. Embodiments of the present invention could be used, for example, to evaluate context from either media being displayed or from ambient noise in a specific area to display the appropriate messages.

Waiting rooms present a unique opportunity to capture ambient sound and gauge the context of topical conversations and to target ads or informational content that matches the conversation. In an environment, such as this, certain keywords will have an elevated value compared to other public venues. One possible usage for this technology in this setting would be to use image detection and keyword detection with video or audio streams playing on a screen, but give precedence to specific terms that may be captured over an ambient microphone.

Campuses and campus administrators are constantly looking for ways to communicate messages to their students. Embodiments of the present invention could be used in student union buildings or other places of congregation to target media and content to the specific audience.

Digital screens are becoming more and more prevalent in corporate offices, from the front desk lobbies, to conference rooms and even in some common areas. One potential use for the system's unique capabilities would be for screens installed in board conference rooms or even board rooms to display messages or key notes based on a presenter's content.

There are many dynamic digital signage players in bars and restaurants. Defining the demographics and therefore catering advertising is relatively straightforward. However, embodiments of the present invention may provide the ability to take ambient sound and incorporate that into advertising on digital signage screens. For example if there are many games on many screens in a sports bar, there will typically only be one audio feed ‘broadcasted’ on the overhead speaker system. This technology will allow digital signage screens that aren't displaying the event that is tied to the audio, to show advertising content that is contextually relevant to what is being heard by the patrons.

Traditional television is increasingly being viewed outside of the home or on screens other than traditional home television sets. More and more consumers are watching television or other similar video feeds on their computer and mobile phones. These technologies are much more portable than a traditional television and there for provide an opportunity for this technology to utilize location information display relevant content. Embodiments of the present invention may be integrated into a GPS enabled mobile phone, and a user may be shown adverts or information from companies or organizations in their immediate proximity.

Embodiments of the present invention may be designed to accommodate multiple billing or revenue models. The system can be installed to be used on an ongoing basis or used for specific events occasions or displays.

Advertisement Share—Advert sharing models are most applicable when one or more system providers are involved. This is an advert revenue model where a digital signage provider has identified and made a deal to install a system at a location. Typically the provider will pay for the install and the location will be given the opportunity to do some on-premise advertising. The remaining advert slots are divided up between the system providers and can be sold independently to brands or agencies or can be sold to aggregators who focus on national media buys.

Revenue Share—In exchange for the real estate, many digital signage providers are willing to share revenue with a venue operator. This system's ability to prioritize contextual advertisements will bring in higher marketing dollars, which benefits digital signage providers and venues wherever digital advertising is utilized.

Cross Promotional—Many digital signage providers will engage in a cross promotional business model to promote to different product offerings to similar demographics. An example would be a nutrition store promoting and gym on their digital signage in exchange for the gym dedicating a few ad slots to the nutrition retailer. Often these promotions will offer benefits to one location's members or customers with proof of purchase or a membership card from the other. Additional in the cross-promotional model venues could use this technology to give preferred advert spots or tie specific keywords with advertisements from their vendors.

Customer Bill—Many venue operators view digital signage as a way to provide value to their patrons be it in the format of entertainment, information, or even specialized offers via adverts. For customers that wish to manage their own network or have complete control over the content that is displayed on their screens or digital signage, there is an opportunity for them to purchase a stand alone (i.e. not part of a larger network) system. In this scenario, the venue operator would be responsible for paying for the system and another upfront cost associated with establishing the system, and would pay a monthly or annual software license fee to the system supplier for the use of the technology.

Licensing—The system is capable of integrating with most media playing devices. It is best suited for digital signage and the display of advertising or informational content but other uses are foreseen. Third parties who are interested in using their own display and media player technologies may be permitted to use the system in exchange for payment of a licensing fee to the system provided.

Non-Digital Out of Home Opportunities—The system has a particularly large commercial opportunity in the Digital Out of Home space, however there are some equally attractive opportunities in the consumer market. One potential application of this technology, that is easily implementable, would be incorporation into digital picture frames. For example, a digital picture frame with family vacation photos may start showing appropriate photos based on the conversation happening in the same room as the frame. Users would also be able to give specific verbal direction to the frame to display certain pictures either based on file names or images contained in the photos.

The scheduling engine may be used to display relevant data during specific time of day or time of year.

Presentation Tools—This system may also have application in an office or corporate setting. It could be used in presentations to dynamically capture message and display notes on a screen. Alternatively graphics, canned messages, charts or informational content could be displayed based on keywords captured by ambient microphones. Use as a presentation medium is another potential function for this technology that does not require the use or implementation of all modules.

The ability to display media, messages and content based on multi-contextual cues is a unique offering. This system has an especially large commercial opportunity in the digital out of home space where there are no comparable technologies. It also has the potential to greatly enhance a number of consumer and commercial products that are currently on the market.

Also, the system addresses the ‘ad on ad’ problem that is encountered by many marketers, by providing ‘ad on ad’ avoidance.

For example, the media content being monitored or tracked to provide context identification may be the standard 15- to 30-second TV advertisements that are aired by TV or cable broadcasters. This therefore enables the system to react to the original media content's advertising.

This may serve two purposes: first to prevent conflicting advertisements played in parallel (which advertisers want to avoid), known as “ad conflict” and, second, to allow for reinforcement of standard TV ad campaigns (which advertisers will often pay a premium for), known as “campaign reinforcement”.

Regarding “ad conflict” prevention, the general goal is to identify when a commercial break is occurring and wait until the regular programming occurs in order to place the informational content around the “squeezed” media content, i.e. the media content being displayed with a reduced x and y axes to enable the informational content to be displayed around the edges of the media content. By assuring advertisers that the advert delivery system will only place adverts during “high attention” programming, instead of “low attention” commercial breaks, a premium may be charged for the advertising. Embodiments of the invention achieve this by focusing the context identification on distinguishing between media content that is original broadcaster advertisements versus entertainment programming, and placement rules that are implemented by the rules engine that only place informational content during periods of entertainment programming.

Regarding “campaign reinforcement”, it is common practice in regular TV advertising for a broadcast network to follow a longer (e.g. 30-second) ad with a number of shorter (e.g. 15-second) ads that serve as a cost-effective means of reinforcing the message delivered more fully in the longer ad. The challenge with traditional TV advertising is that viewers often switch channels, resulting in exposure to a longer ad without the reinforcing shorter ads, or a somewhat confusing exposure to a shorter ad without the benefit of seeing the original ad. According to various embodiments of the invention, the system can place “reinforcing” informational content to follow after the TV has shown a long, traditional “full screen” advert aired by any network on any channel. In other words, the media content being focused on for collecting context information is not the entertainment programming (e.g. Simpsons on Fox) but the advert programming played by the TV (e.g. Coke ad, whether on Simpsons/Fox or the NBC show that was watched just previously).

Currently, without manually scheduling media content on a location-by-location basis, there is no known method for assuring that content in digital signage will be played in context with its environment. The ability to play media on a display, screen or picture frame based on contextual cues can also be implemented outside of the DOOH space. There are currently tools for interacting with digital screens, obviously remote controls, keyboards and mice.

Further, the system may be used in a unique manner to intelligently and automatically drive display devices.

According to a further embodiment, similar systems, modules and methods as described herein may be used to detect the context of incoming media content and informational content. Further, similar systems, modules and methods as described herein may be used to match the context of the incoming media content with contextually relevant informational content. As an alternative to the above described embodiments, the system may be modified so that existing informational content is replaced with the contextually based information content as described in more detail below. That is, the contextually based information content is displayed instead of the originally programmed or scheduled information content.

The system includes a modified informational content scheduling module that is arranged to detect the start and end times for outputting informational content, such as television advertisements, video, audio etc. For example, the start time may be the detected end of a program or a detected start point for advertisement breaks. The end time may be the detected start of a program or a detected end point for advertisement breaks. Any suitable known means may be applied to determine the start and end times. For example, markers or reception signals may be detected or monitored.

The system includes one or more of the various modules and engines already described herein to monitor the incoming media content in order to develop contextual data associated with the media content and determine the most relevant contextually related informational content that is to be displayed. Upon determining which contextually related informational content is to be scheduled, the system replaces the originally scheduled informational content with the contextually related informational content during the period determined by the informational content scheduling module based on the start and end times.

In the case of video informational content, one of the methods used to replace the original scheduled informational content with the newly scheduled contextually relevant informational content may be by way of inserting the new content within the broadcast stream, for example. The system may include a switching device that switches between the regularly scheduled informational content and the contextually relevant informational content based on a signal received from the informational content scheduling module.

Alternatively, the newly scheduled contextually relevant informational content may be output over the top of the originally scheduled information content such that the newly scheduled informational content overlays the original.

In the case of audio informational content, the newly scheduled informational content may be inserted to replace the original as described above in relation to video informational content.

Alternatively, the volume level of the original content may be reduced while playing back the newly scheduled informational content, such that the newly scheduled information content is played over the original.

The newly scheduled contextually relevant informational content is thus output, such as displayed on a full screen for example, without the user knowing that the original informational content has been replaced.

Locational information, obtained using methods as previously described herein, may also be used in this embodiment to direct more relevant informational content to the user based on their location. For example, set top boxes that are used by consumers to watch subscriber related media content are allocated to individuals and have unique addresses. Using the unique address of the set top box and the subscriber's known location, relevant location related informational content can be distributed.

It will be understood that the relevant alternatives and options described above also apply to this embodiment.

It will be understood that the embodiments of the present invention described herein are by way of example only, and that various changes and modifications may be made without departing from the scope of invention.

Further, it will be understood that the informational content may include streaming video data, still image data, audio data or a combination thereof.

Further, it will be understood that the media content may include one or a combination of video streaming data, still image data, and audio data associated with images formed by the media content.

Further, it will be understood that although the media content may be received by the scheduling system in any suitable form. For example, the media content may consist of media data files that can be transferred or communicated between computing systems. Further, the media content may be stored on any suitable storage medium, such as, for example, a DVD, a hard drive, a flash drive and a memory stick.

Further, it will be understood that the context detection methods described herein may be implemented on one or more remote devices or sites other than the device that is arranged to output the media content. That is, for example, a first device may be arranged to output media content without the capability of detecting the context of the media content, for example by capturing closed caption data for the purposes of analyzing the context of the media content. A second device remote to the first device may however be used in conjunction with the first device to determine the context of the media content. The system may determine which media content is being output on the first device by detecting, for example, information identifying the current channel being displayed and relating this to a known schedule. By identifying that the second device is also outputting the same media content, the context analysis steps, such as for example the closed caption capturing techniques, used on the second device may be used to determine and schedule context related information content for the first device. Alternatively, the context analysis may be performed at the broadcasting site as the media content is output to the devices. After determining the context, the appropriate context related informational content can be output on the first device and optionally the second device by transmitting the informational content identification information or the actual informational content itself. It will be understood that the same techniques discussed above may also be applied to other context related data other than closed caption data.

1. In an informational content scheduling system, a computer implemented method for scheduling the output of informational content received from an informational content source with media content, the method including the steps of an informational content scheduling module:
monitoring media content output from an independent media content source,
analysing the received media content, wherein the analysis captures media content context data that identifies the context of the media content,
identifying informational content to be scheduled by correlating the media content context data with informational content context data, wherein the informational content context data identifies the context of the informational content,
scheduling the informational content based on the correlating step,
detecting whether the informational content is scheduled, and upon a positive determination, modifying the format of the media content to enable the informational content and media content to be displayed simultaneously, wherein the format of the media content is modified by adjusting the size of an image of the media content.

2. The method of claim 1 further including the step of displaying the media content and informational content on a media content display area normally allocated for displaying the media content when the informational content is not scheduled.

3. The method of claim 1 further including the step of sending display data to a media content output device to enable the simultaneous display of media content and informational content on the media content output device.

4. The method of claim 3 wherein the display data includes instructions for modifying the format of the media content to enable the informational content to be displayed adjacent to the media content when the media content is displayed on the media content output device.

5. The method of claim 4 wherein the display data includes further instructions for reverting the format of the media content back to its original format after the informational content has been displayed.

6. The method of claim 1 wherein the step of scheduling includes the steps of:
retrieving the identified informational content, and
outputting the retrieved informational content.

7. The method of claim 6 further including the step of transmitting the informational content to an informational content output device for contemporaneous output with the media content from a media content output device.

8. The method of claim 7, wherein the informational content is output from an informational content output device and the media content is output from a media content output device, and the informational content output device and media content output device are one and the same device.

9. The method of claim 8 further including the step of modifying the format of the media content to enable the informational content to be displayed adjacent to the media content when the media content is displayed on the media content output device.

10. The method of claim 8 further including the step of reverting the format of the media content back to its original format after the informational content has been displayed.

11. The method of claim 8 further including the step of arranging the informational content to be displayed in an at least partially transparent manner.

12. The method of claim 7, wherein the informational content is output from an informational content output device and the media content is output from a media content output device, and the informational content output device and media content output device are different devices.

13. The method of claim 12, wherein the informational content output device and media content output device are located in the same localized area.

14. The method of claim 12, wherein the informational content output device is an integral component of the informational content scheduling module.

15. The method of claim 6, further including the step of outputting the retrieved informational content to replace originally scheduled informational content.

16. The method of claim 1 further including the steps of the informational content scheduling module:
transmitting the media content context data to an external data source to correlate the media content context data with the informational content context data at the external data source, and, based on the correlation,
receiving informational content identification data that identifies the informational content to be scheduled, and
scheduling the informational content based on the informational content identification data.

17. The method of claim 16, wherein the informational content identification data includes the informational content.

18. The method of claim 1 further including the steps of the informational content scheduling module correlating the media content context data with informational content context data that is stored locally on the informational content scheduling module.

19. The method of claim 1 further including the step of assigning informational content context data to the informational content by manually assigning the informational content context data to the informational content based on the informational content's context.

20. The method of claim 1 further including the step of assigning informational content context data to the informational content by detecting at least one of closed caption data, audio data and video data within the informational content, and
analysing the detected data to detect one or more identification components that form at least part of the informational content context data.

21. The method of claim 1, wherein the analysis step further includes the steps of:
detecting at least one of closed caption data, audio data and video data within the media content, and
analysing the detected data to detect one or more identification components that form at least part of the media content context data.

22. The method of claim 21 further including the step of applying the identification components to a rules engine to identify the informational content that is to be scheduled.

23. The method of claim 21 further including the step of assigning weight values to the detected identification components to identify the informational content that is to be scheduled.

24. The method of claim 23 further including the steps of:
analysing the detected identification components to identify at least one of a theme, media channel or media program,
and based on the identified theme, media channel or media program
selecting a sub-set of the informational content context data to correlate with the media content context data.

25. The method of claim 20 or 21 further including the step of:
identifying a key image as an identification component within video data.

26. The method of claim 25 further including the steps of:
determining an identification text string associated with the key image as an identification component.

27. The method of claim 26 further including the step of determining the identification text string by detecting text within the key image.

28. The method of claim 26 further including the step of determining the identification text string by:
searching a database for an image similar to the key image, and allocating a database reference of any found similar image as the identification text string.

29. The method of claim 26 further including the step of determining the identification text string by:
searching a database for an image similar to the key image, and allocating a text reference stored within the database that is associated with the found similar image as the identification text string.

30. The method of claim 25 further including the step of identifying an image or part thereof as the key image when it is detected as being present in the video data for display for more than a preset time period.

31. The method of claim 25 further including the step of identifying an image or part thereof as the key image when it is detected as being present in the video data for display for more than a preset number of times.

32. The method of claim 20 or 21 further including the steps of:
transcribing detected closed caption data or audio data into transcribed data, and
parsing the transcribed data to find a keyword or key phrase as an identification component.

33. The method of claim 32 when dependent on claim 21 further including the step of detecting the audio data from within the media content as it is received by the informational content scheduling module.

34. The method of claim 32 when dependent on claim 21 further including the step of detecting the audio data from audio output signals received by an audio capture device positioned near a media content output device arranged to play the media content.

35. The method of claim 1, further including the steps of analysing ambient data retrieved in the vicinity of the informational content output device arranged to output the scheduled informational content, and
determining the scheduling based on the ambient data analysis.

36. The method of claim 35 wherein the ambient data is one or a combination of data based on detected ambient audio signals or ambient video signals.

37. The method of claim 35 further including the step of detecting user characteristics from the ambient data.

38. The method of claim 37 wherein the detected user characteristics include at least one of the number of users in the vicinity of the informational content output device, the gender of the user and the position of the user in relation to the informational content output device.

39. The method of claim 35 further including the step of adjusting which informational content is scheduled based on the analysed ambient data.

40. The method of claim 35 further including the step of adjusting how the informational content is output based on the analysed ambient data.

41. The method of claim 1, wherein the scheduling step further includes the steps of:
retrieving informational content usage data,
analysing the media content context data to determine a contextual meaning output and a weighting value associated with the media content context data, and
scheduling the informational content based on a set of pre-stored scheduling rules that utilize the informational content usage data, contextual meaning output and weighting value.

42. The method of claim 41 wherein the step of determining the contextual meaning output and weighting value further include the steps of:
looking up the media content context data in a database, and
retrieving the contextual meaning output and weighting value from a media content context data database record associated with the media content context data.

43. The method of claim 41 wherein the contextual meaning output identifies the contextual meaning of the media content.

44. The method of claim 41 wherein the weighting value affects how the informational content is scheduled.

45. The method of claim 44 wherein a positive weighting value positively affects how the informational content is scheduled.

46. The method of claim 44 wherein a positive weighting value negatively affects how the informational content is scheduled.

47. The method of claim 41 wherein the pre-stored scheduling rules affect at least any one of the start time, end time, duration, frequency, manner of display or type of the scheduled informational content.

48. The method of claim 1 further including the step of scheduling the informational content based on location information associated with the location of an informational content output device arranged to play the informational content.

49. The method of claim 48 further including the steps of determining which informational content output device the informational content is to be played, and retrieving the location information associated with the determined informational content output device from a data storage module.

50. The method of claim 48 further including the step of receiving location information from the informational content output device.

51. The method of claim 50 further including the step of retrieving ambient data to determine the location of the informational content output device.

52. The method of claim 48 further including the step of receiving location information from a location information source that is in communication with the informational content output device.

53. The method of claim 1 further including the step of scheduling the informational content based on information received from content based sources.

54. The method of claim 53, wherein the content based sources include at least one of a weather content source, a news content source, a financial content source, an entertainment content source and a sports content source.

55. The method of claim 1, wherein the informational content scheduling module forms at least part of a television device, a mobile television device, a multimedia playing device, a home computing device, a portable computing device, a portable communication device, a satellite signal receiving device, a terrestrial broadcast signal receiving device, a digital data receiving device, a cable signal receiving device, a multi entertainment device, a photograph display device or a presentation device.

56. The method of claim 1, wherein the informational content includes advertisements, alert messages or advisory messages.

57. The method of claim 1, wherein the informational content is displayed in a forceful manner.

58. The method of claim 1, wherein the informational content includes streaming video data, still image data, audio data or a combination thereof.

59. The method of claim 1, wherein the media content includes one or a combination of video streaming data, still image data, and audio data associated with images formed by the media content.

60. The method of claim 1, wherein the media content is a full-screen advertisement aired by a TV or cable broadcaster.

61. The method of claim 1, wherein the media content is broadcast data.

62. The method of claim 61, wherein the broadcast data is one of television data, cable data and satellite data.

63. The method of claim 62, wherein the television data is at least one of terrestrial television data, mobile television data, and web television data.

64. The method of claim 1, wherein the media content is read from a storage medium.

65. The method of claim 64, wherein the storage medium is one of a DVD, a hard drive, a flash drive and a memory stick.

66. The method of claim 1 further including the steps of:
retrieving location information based on the location of an informational content output device arranged to output informational content, and
utilizing a set of pre-stored rules determining the scheduling of the informational content based on the location information.

67. An informational content scheduling system for scheduling the output of informational content received from an informational content source with media content, the system including an informational content scheduling module arranged to:
monitor media content output from an independent media content source,
analyze the received media content, wherein the analysis captures media content context data that identifies the context of the media content,
identify informational content to be scheduled by correlating the media content context data with informational content context data, wherein the informational content context data identifies the context of the informational content,
schedule the informational content based on the correlation of the media content with the information content,
detect whether the informational content is scheduled, and upon a positive determination, modify the format of the media content to enable the informational content and media content to be displayed simultaneously, wherein the format of the media content is modified by adjusting the size of an image of the media content.

68. The system of claim 67 wherein the informational content scheduling module is further arranged to display the media content and informational content on a display area normally allocated for displaying the media content when the informational content is not scheduled.

69. The system of claim 67 wherein the informational content scheduling module is further arranged to retrieve location information based on the location of an informational content output device arranged to output informational content, and
utilize a set of pre-stored rules determining the scheduling of the informational content based on the location information.
